(19) United States
(12) Patent Application Publication
(10) Pub. No.: US 2026/0307651 A1
(43) Pub. Date: Oct. 8, 2026

(54) VEHICLE CONTROL DEVICE

(71) Applicant: TOYOTA JIDOSHA KABUSHIKI KAISHA, Toyota-shi (JP)

(72) Inventor: Kenta Kumazaki, Tokyo-to (JP)

(73) Assignee: TOYOTA JIDOSHA KABUSHIKI KAISHA, Toyota-shi (JP)

(21) Appl. No.: 19/542,191

(22) Filed: Feb. 17, 2026

(30) Foreign Application Priority Data
Apr. 8, 2025 (JP) 2025-063775

(51) Int. Cl. B60W 30/18; B60W 50/00; B60W 50/10

(52) U.S. Cl. CPC B60W 30/18163; B60W 50/0097; B60W 50/10; B60W 2520/10; B60W 2520/105; B60W 2540/215; B60W 2552/10; B60W 2720/106

(57) ABSTRACT

A vehicle control device includes a processor configured to: determine whether or not a lane change condition is satisfied, the lane change condition being a condition that execution of lane change control is required or predicted, determine whether or not a deceleration condition is satisfied, the deceleration condition being a condition that execution of a predetermined deceleration control is required, and execute the predetermined deceleration control so that the decelerated speed of the vehicle by the predetermined deceleration control is equal to or higher than a lower limit speed at which the lane change control can be executed, and executes the lane change control, when both the lane change condition and the deceleration condition are satisfied, and a priority of the predetermined deceleration control is lower than a priority of the lane change control.

### FIELD

The present invention relates to a vehicle control device that automatically controls a vehicle speed.

### BACKGROUND

When it is determined that a vehicle can move forward in a blind spot region of a parallel-running vehicle by traveling in accordance with a cruise condition, it is proposed that the control of the speed of the vehicle by a cruise control is prioritized to the control of the speed of the vehicle by a blind spot avoidance control in which the vehicle is positioned behind the blind spot region (see Japanese Patent JP6881221B).

### SUMMARY

By executing the deceleration control for decelerating the vehicle, such as the blind spot avoidance control described above, the lane change may not be performed even if the vehicle is tried to automatically chang lanes.

Therefore, it is an object of the present invention to provide a vehicle control device capable of executing deceleration control of a vehicle so that execution of lane change control is not interfered.

A vehicle control device provided by one embodiment includes a processor configured to: determine whether or not a lane change condition is satisfied based on a position of a vehicle or an operation signal indicating an operation by a driver of the vehicle, the lane change condition being a condition that execution of lane change control for moving the vehicle from a host lane on which the vehicle is traveling to an adjacent lane adjacent to the host lane is required, or the execution of the lane change control is predicted, determine whether or not a deceleration condition is satisfied based on a behavior signal representing a behavior of the vehicle or an exterior sensor signal representing a situation around the vehicle, the deceleration condition being a condition that execution of a predetermined deceleration control for decelerating the vehicle is required, and execute the predetermined deceleration control so that the decelerated speed of the vehicle by the predetermined deceleration control is equal to or higher than a lower limit speed at which the lane change control can be executed, and executes the lane change control, when both the lane change condition and the deceleration condition are satisfied, and a priority of the predetermined deceleration control is lower than a priority of the lane change control.

The vehicle control device according to the present disclosure has an effect that the vehicle can execute deceleration control of a vehicle so that the execution of lane change control is not interfered.

### BRIEF DESCRIPTION OF DRAWINGS

FIG. 1 schematically illustrates the configuration of a vehicle on which a vehicle control device is mounted.

FIG. 2 is a functional block diagram of a processor of an ECU related to a vehicle-control process.

FIG. 3 is a time chart illustrating an example of deceleration control and lane change control.

FIG. 4 is a time chart illustrating an example of the priority transition of the deceleration control and the lane change control.

FIG. 5 is an operation flowchart of the vehicle control process.

### DESCRIPTION OF EMBODIMENTS

Hereinafter, a vehicle control device, a vehicle control method, and a computer program for vehicle control will be described with reference to the drawings. When both a lane change condition and a deceleration condition are satisfied and the priority of the deceleration control is lower than the priority of the lane change control, the vehicle control device executes the lane change control while executing the deceleration control such that the speed after the deceleration of the vehicle by the deceleration control is equal to or higher than the lower limit speed (hereinafter referred to as LC lower limit speed) capable of executing the lane change control.

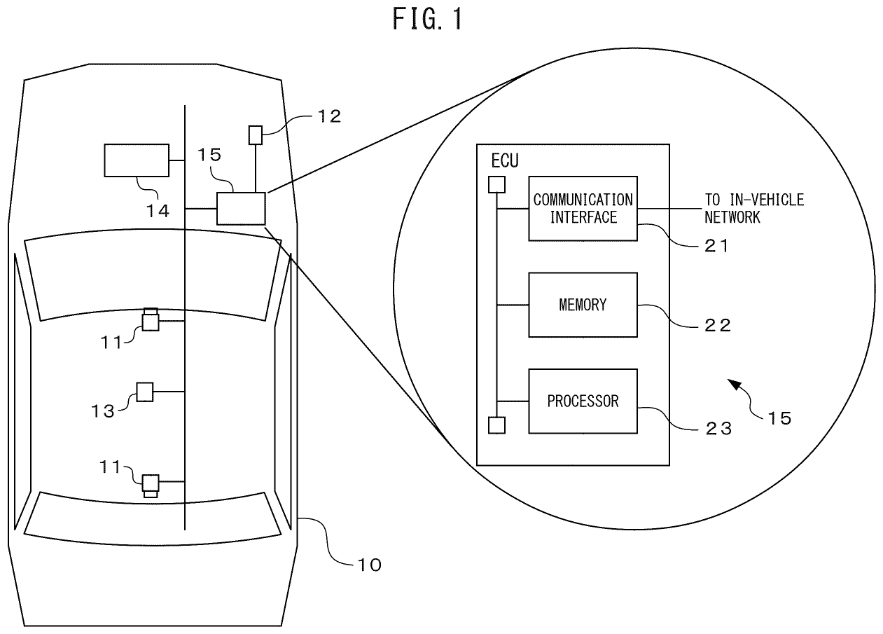

FIG. 1 schematically illustrates the configuration of a vehicle on which a vehicle control device is mounted. In the present embodiment, the vehicle 10 includes an exterior sensor 11, a behavior sensor 12, a GPS receiver 13, a storage device 14, and an electronic control unit (ECU) 15 that is an example of a vehicle control device. The exterior sensor 11, the behavior sensor 12, the GPS receiver 13, and the storage device 14 are communicably connected to the ECU 15. The vehicle 10 may further include a navigation device (not shown) that searches for a route to be traveled to a destination.

The exterior sensor 11 is a sensor that generates an exterior sensor signal representing a situation around the vehicle 10, and is a camera that is provided so as to be capable of capturing an image of a predetermined area around the vehicle 10 (for example, a front area or a rear area of the vehicle 10), or a range sensor such as a radar or a LiDAR that detects a distance to an object with respect to each azimuth. An image representing a predetermined region of the vehicle 10 generated by a camera, which is an example of the exterior sensor 11, is an example of an exterior sensor signal. Further, a ranging signal representing a distance to an object for each azimuth within a predetermined angle range generated by a range sensor that is another example of the exterior sensor 11 is another example of the exterior sensor signal. The vehicle 10 may be provided with a plurality of exterior sensors 11 having different detectable ranges or types. In particular, it is preferable that a plurality of exterior sensors 11 are provided in the vehicle 10 so as to be able to detect the entire periphery of the vehicle 10. In the example of FIG. 1, two exterior sensors 11 are shown. The exteriot sensor 11 outputs the generated exterior sensor signal to the ECU 15 every time the exterior sensor signal is generated.

The behavior sensor 12 is a sensor that generates a behavior signal representing the behavior of the vehicle 10, and is, for example, a speed sensor for detecting the speed of the vehicle 10. In addition to the speed sensor, the vehicle 10 may be provided with a plurality of behavior sensors 12 of different types, such as an acceleration sensor or a gyro sensor. The vehicle speed signal representing the speed of the vehicle 10 generated by the speed sensor, which is an example of the behavior sensor 12, is an example of a behavior signal. Each time the behavior signal is generated, the behavior sensor 12 outputs the generated behavior signal to the ECU 15.

The GPS receiver 13 receives GPS signals from GPS satellites at predetermined intervals, and measures the position of the vehicle 10 based on the received GPS signals. Then, the GPS receiver 13 outputs, to the ECU 15, the positioning information indicating the measuring result of the position of the vehicle 10 based on GPS signals at each predetermined cycle. In place of the GPS receiver, the vehicle 10 may include a receiver that receives positioning signals from satellites of other satellite positioning systems to determine the position of the vehicle 10.

The storage device 14 is an example of a storage unit, and includes, for example, a hard disk device, a nonvolatile semiconductor memory, or an optical recording medium and an access device thereof, and stores map information. The map information includes information indicating the position and the range of each road section, a maximum speed and a number of lanes in each road section, a curvature of each road section, and information indicating a feature such as a road marking, a road sign, or a curb existing in or around each road section.

The ECU 15 executes a vehicle control process including a deceleration control for automatically decelerating the speed of the vehicle 10 and a lane change control for automatically moving the vehicle 10 from a host lane on which the vehicle 10 is traveling to an adjacent lane adjacent to the host lane, as an example of the autonomous driving control or the driving support control.

The ECU 15 includes a communication interface 21, a memory 22, and a processor 23. The communication interface 21, the memory 22, and the processor 23 may be configured as separate circuits, or may be integrally configured as a single integrated circuit.

The communication interface 21 has interface circuitry for connecting the ECU 15 to other devices. The communication interface 21 passes the exterior sensor signal received from the exterior sensor 11, the behavior signal received from the behavior sensor 12, the positioning information received from the GPS receiver 13, and the map information read from the storage device 14 to the processor 23. Furthermore, the communication interface 21 passes an operation signal received from an operation device (not shown) of the vehicle 10 provided in the vehicle 10 to the processor 23.

The memory 22 is another example of a storage unit, and includes, for example, a volatile semiconductor memory and a non-volatile semiconductor memory. The memory 22 stores various types of data used in the vehicle control process executed by the processor 23. For example, the memory 22 stores the priority of each control. The memory 22 also stores various parameters related to the exterior sensor 11 (for example, a focal length, a shooting direction and a mounting position of the camera, and an angular range to be a distance measurement target for the range sensor). Further, the memory 22 temporarily stores positioning information, an exterior sensor signal, a behavior signal, map information, and various data generated during executing the vehicle control process.

The processor 23 includes one or more central processing units (CPUs) and a peripheral circuit thereof. The processor 23 may further include other arithmetic circuits such as a logical operation unit, a numerical operation unit, or a graphics processing unit.

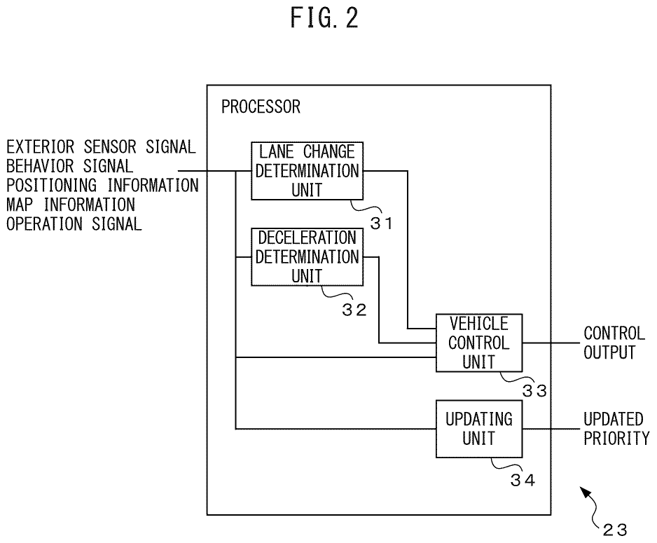

FIG. 2 is a functional block diagram of the processor 23 related to vehicle control process. The processor 23 includes a lane change determination unit 31, a deceleration determination unit 32, a vehicle control unit 33, and an updating unit 34. Each of these units included in the processor 23 may be, for example, a functional module realized by a computer program running on the processor 23, or a dedicated arithmetic circuit provided in the processor 23.

The lane change determination unit 31 determines whether or not the lane change condition is satisfied based on the position of the vehicle 10 or an operation signal indicating an operation by the driver of the vehicle 10. The lane change condition is a condition in which execution of the lane change control is requested or execution of the lane change control is predicted.

When any of the following conditions is satisfied, the lane change determination unit 31 determines that the lane change condition is satisfied.
(i) In a planned traveling route set by a navigation device, a distance from a current position of the vehicle 10 to an intersection in which the vehicle 10 turns right or left or a branch becomes equal to or less than a predetermined distance, and the host lane and a lane toward a destination indicated in the planned traveling route are different from each other.
(ii) A lane reduction section or a merging section is present in a section from a current position of the vehicle 10 to a predetermined distance destination, and the host lane is a lane which is eliminated in the lane reduction section or the merging section (hereinafter, referred to as a vanishing lane).
(iii) The driver performed an operation that triggers the lane change control.

In order to determine whether or not the condition (i) is satisfied, the lane change determination unit 31 refers to the map information, identifies the road section including the current position of the vehicle 10 as the road section in which the vehicle 10 is traveling, and identifies the lane including the current position of the vehicle 10 as the host lane in the road section. The lane change determination unit 31 sets the position indicated by the latest positioning information as the current position of the vehicle 10. Alternatively, the lane change determination unit 31 may identify the current position of the vehicle 10 by matching the image generated by the camera, which is an example of the exterior sensor 11, with the map information. In this case, the lane change determination unit 31 detects individual features existing around the vehicle 10 from the image, and projects the detected individual features onto the map information assuming the position and attitude of the vehicle 10. Then, the lane change determination unit 31 calculates the degree of coincidence between each feature detected from the image and the corresponding feature represented on the map information (for example, the sum of squares the distance between the detected individual feature and the corresponding feature on the map information, or the inverse of the sum). The lane change determination unit 31 calculates the degree of coincidence while variously changing the assumed position and attitude of the vehicle 10, and specifies the position of the vehicle 10 when the degree of coincidence is maximized as the current position of the vehicle 10.

The lane change determination unit 31 detects a feature represented in an image by inputting an image to a classifier trained in advance so as to detect a feature. The classifier may be configured as a deep neural network (DNN) having a convolutional neural network (CNN) type architecture or as a DNN having an attention mechanism such as Vision Transformer.

When the lane change determination unit 31 identifies the host lane, it refers to the map information and the planned traveling route to calculate the distance along the planned traveling route to the branch or the intersection where the vehicle 10 turns right or left next. When the distance is less than or equal to a predetermined distance (e.g., 1 to 3km), the lane change determination unit 31 determines whether or not the host lane differs from a lane traveling toward the destination of the vehicle 10 at the branch or the intersection at which the vehicle 10 turns right or left next (hereinafter, referred to as a traveling direction lane). When the host lane and the traveling direction lane are different from each other, the lane change determination unit 31 determines that the condition (i) is satisfied, that is, the lane change condition is satisfied. Then, the lane change determination unit 31 sets the relative position of the traveling direction lane with respect to the host lane as information indicating the adjacent lane of the moving destination.

In order to determine whether or not the above condition (ii) is satisfied, the lane change determination unit 31 refers to the map information and the current position of the vehicle 10 as described above, and identifies the road section and the host lane in which the vehicle 10 is traveling. Further, the lane change determination unit 31 refers to the map information to determine whether a lane reduction section or a merging section is present within a predetermined distance from the current position of the vehicle 10 in the traveling direction of the vehicle 10 indicated by a direction sensor (not shown) mounted on the vehicle 10. When there is a lane reduction section or a merging section, the lane change determination unit 31 refers to the map information to determine whether or not the host lane matches the vanishing lane. When the host lane and the vanishing lane coincide with each other, the lane change determination unit 31 determines that the condition (ii) is satisfied, that is, the lane change condition is satisfied. Then, the lane change determination unit 31 sets the relative position of the lane maintained in the lane reduction section with respect to the host lane as the information indicating the adjacent lane of the moving destination.

When the lane change determination unit 31 receives an operation signal indicating that the operation device is operated from an operation device, such as a winker, indicating a lane change to the surroundings, it determines that the condition (iii) is satisfied, that is, the lane change condition is satisfied. In addition, the lane change determination unit 31 sets the direction (left or right) indicated by the operation signal as the information indicating the adjacent lane of the moving destination.

When the lane change condition is satisfied, the lane change determination unit 31 sets the priority of the lane change control to the value of the priority stored in the memory 22. The priority is an index indicating a priority level related to the execution of the corresponding control, and the higher the priority, the more preferentially the control. When the priority of the lane change control is adjusted by the updating unit 34, the lane change determination unit 31 sets the priority of the lane change control to the adjusted priority.

When the lane change condition is satisfied, the lane change determination unit 31 notifies the vehicle control unit 33 that the lane change condition is satisfied. The lane change determination unit 31 further notifies the vehicle control unit 33 of the information indicating the adjacent lane of the moving destination, and the priority of the lane change control.

The deceleration determination unit 32 determines whether or not a deceleration condition that requires execution of a predetermined deceleration control for decelerating the vehicle 10 is satisfied, based on the behavior signal or the exterior sensor signal.

The predetermined deceleration control includes the control following as:
(a) A deceleration control executed for giving a sense of security to an occupant of the vehicle 10 or for safety of the vehicle 10. Such deceleration control includes deceleration in an adaptive cruise control, deceleration associated with prediction that another vehicle will cut in front of the vehicle 10, deceleration for speed management in a curve, and deceleration before an expressway exit or a tollgate.
(b) A deceleration control that is executed for convenience without the driver's intent. Such deceleration control includes deceleration executed when the adjacent lane is congested, deceleration executed to avoid parallel travel, and deceleration caused by pulse-and-glide travel (hereinafter referred to as PG travel).

When it is required to execute the deceleration control of (a) or (b), the deceleration determination unit 32 determines that the deceleration condition is satisfied.

The deceleration determination unit 32 detects a preceding vehicle traveling on the host lane based on the exterior sensor signal. When the distance between the preceding vehicle and the vehicle 10 is less than the predetermined distance threshold, the deceleration determination unit 32 determines that the deceleration is executed in accordance with the adaptive cruise control, that is, the deceleration condition is satisfied.

The deceleration determination unit 32 detects the preceding vehicle based on the exterior sensor signal. The deceleration determination unit 32 detects another vehicle and lane division lines by inputting an image representing a front region of the vehicle 10, which is an example of an exterior sensor signal, to a classifier trained in advance so as to detect another vehicle and each lane division line. Such a classifier may be a classifier similar to the classifier for feature detection described above. Further, since the position on the image corresponds one-to-one to the azimuth as viewed from the camera, the position of the object region in which another vehicle is represented on the image corresponds to the azimuth from the vehicle 10 to the other vehicle. Therefore, the deceleration determination unit 32 identifies, as the preceding vehicle, the other vehicle represented in the image at a position corresponding to the traveling direction of the vehicle 10. Alternatively, the deceleration determination unit 32 may specify, as the preceding vehicle, among each of the other vehicles, which is represented in the object region whose lower end is included in the region corresponding to the host lane sandwiched between the two lane division lines closest to the vehicle 10 in the image by a predetermined ratio (for example, 70% to 90%) or more, the other vehicle included in the object region represented at the position closest to the bottom end of the image.

It is assumed that the position of the lower end of the object region in which the preceding vehicle is represented indicates the position at which the preceding vehicle is in contact with the road surface. As described above, the position on the image corresponds one-to-one to the direction viewed from the camera that generated the image. Therefore, the deceleration determination unit 32 can estimate the distance from the vehicle 10 to the preceding vehicle by referring to the position of the lower end of the object region on the image and parameters of the camera such as the installation height and the photographing direction.

Further, the deceleration determination unit 32 may detect the other vehicle by inputting a ranging signal, which is another example of the exterior sensor signal, to a classifier trained in advance so as to detect the other vehicle from the ranging signal. Such classifier is configured as DNN with CNN or an attention mechanism. The deceleration determination unit 32 may set the other vehicle detected in the azimuth corresponding to the traveling direction of the vehicle 10 as the preceding vehicle, and set the distance detected in the azimuth as the distance between the vehicle 10 and the preceding vehicle.

Further, the deceleration determination unit 32 tracks a target vehicle traveling in the adjacent lane. When the target vehicle approaches the vehicle 10 from the rear side, the relative speed of the target vehicle with respect to the vehicle 10 is greater than or equal to a predetermined speed threshold, and the distance between the vehicle 10 and the target vehicle along the traveling direction of the vehicle 10 is less than the predetermined interval threshold, it is predicted that the target vehicle cut in the front side of the vehicle 10. That is, the deceleration determination unit 32 determines that the deceleration condition is satisfied.

In this case, the deceleration determination unit 32 sets, as the target vehicle, the other vehicle located in a region sandwiching the lane division lines closest to the vehicle 10 on the left or right side of the vehicle 10 among the detected other vehicles. Alternatively, when the distance between the vehicle 10 and the other vehicle along the direction orthogonal to the traveling direction of the vehicle 10 corresponds to the distance between the vehicles traveling in the lanes adjacent to each other, the deceleration determination unit 32 may determine the other vehicle as the target vehicle.

Each time an exterior sensor signal is obtained, the deceleration determination unit 32 calculates the distance and the azimuth (i.e., the relative position) of the target vehicle with respect to the vehicle 10 by the same method as the estimation of the distance between the preceding vehicle and the vehicle 10. The deceleration determination unit 32 may determine the relative speed of the target vehicle with respect to the speed of the vehicle 10 based on the time-series change of the relative position based on the relative position of the target vehicle when the individual exterior sensor signals are obtained, and may determine the relative speed of the target vehicle based on the time-series change of the relative position. Further, the deceleration determination unit 32 may determine whether or not the target vehicle approaches from the rear of the vehicle 10 and whether or not the distance between the vehicle 10 and the target vehicle along the traveling direction of the vehicle 10 is less than the predetermined interval threshold based on the time-series change in the relative position.

Further, the deceleration determination unit 32 refers to the current position of the vehicle 10, the traveling direction of the vehicle 10, and the map information to determine whether there is a curve section within a predetermined distance from the current position of the vehicle 10 in the traveling direction of the vehicle 10. When there is a curve section within the predetermined distance and the current speed of the vehicle 10 is faster than the upper limit speed set according to the curvature of the curve section, the deceleration determination unit 32 determines that the deceleration condition is satisfied. Similarly, the deceleration determination unit 32 refers to the current position of the vehicle 10, the traveling direction of the vehicle 10, and the map information to determine whether or not there is an expressway exit or a tollgate within a predetermined distance from the current position of the vehicle 10 in the traveling direction of the vehicle 10. When there is an expressway exit or a tollgate, the deceleration determination unit 32 determines that the deceleration condition is satisfied.

Further, the deceleration determination unit 32 detects a plurality of other vehicles traveling in the adjacent lane, and estimates the speed of each other vehicle by adding the speed of the vehicle 10 measured by the speed sensor to the detected relative speed of each other vehicle. Then, the deceleration determination unit 32 calculates the average value of the speed of each other vehicle traveling in the adjacent lane based on the estimated value of the speed of each other vehicle, and determines that the adjacent lane is congested and the deceleration condition is satisfied when the average speed is equal to or lower than the congestion determination threshold.

Further, the deceleration determination unit 32 detects the other vehicle traveling in the adjacent lane, and identifies the other vehicle closest to the vehicle 10 among the detected other vehicles as the target vehicle. When the difference between the speed of the target vehicle and the speed of the vehicle 10 is equal to or less than the predetermined speed and the target vehicle is positioned in a direction orthogonal to the traveling direction of the vehicle 10, the deceleration determination unit 32 determines to execute deceleration for avoiding parallel travelling. That is, the deceleration determination unit 32 determines that the deceleration condition is satisfied.

In addition, when PG travel control is executed in which the vehicle 10 repeats the acceleration and the coasting in order to improve the fuel efficiency, when the speed of the vehicle 10 reaches the upper limit of the speed range, the deceleration determination unit 32 determines that the deceleration condition is satisfied.

When any of the above-described deceleration conditions is satisfied, the deceleration determination unit 32 sets a priority corresponding to the satisfied deceleration condition for the deceleration control. In the deceleration control corresponding to the control of (a), a priority higher than the priority of the lane change control is preset. On the other hand, for the deceleration control corresponding to the control of (b), a priority lower than the priority of the lane change control is preset. However, when the priority corresponding to the deceleration condition satisfied by the updating unit 34 is adjusted, the deceleration determination unit 32 sets the adjusted priority. Then, the deceleration determination unit 32 notifies the vehicle control unit 33 that the deceleration condition is satisfied and the set priority.

When the lane change determination unit 31 notifies that the lane change condition is satisfied, the vehicle control unit 33 executes the lane change control to move the vehicle 10 from the host lane to the adjacent lane.

When the execution of the lane change control is started, the vehicle control unit 33 sets the planned traveling trajectory from the current position of the vehicle 10 to the target position on the adjacent lane. To this end, the vehicle control unit 33 predicts the position and the speed at each time point up to a predetermined time point of each other vehicle traveling in the adjacent lane. Based on the prediction result, the vehicle control unit 33 sets, as the target position, a position at which the vehicle 10 is predicted to be able to enter in the adjacent lane of the moving destination. Further, the vehicle control unit 33 sets, as the target vehicle, another vehicle that will travel immediately before the vehicle 10 when the vehicle 10 enters the adjacent lane at the target position.

The vehicle control unit 33 estimates the current speed and acceleration of the other vehicle on the basis of the relative position of the other vehicle and the position of the vehicle 10 at the generation time of the individual exterior sensor signals obtained within the latest predetermined period, assuming that the other vehicle is performing an uniformly accelerated motion. Then, the vehicle control unit 33 predicts the speed and the position of the other vehicle at each time in the future according to the estimated speed and acceleration. Herein, the acceleration includes deceleration.

When a plurality of other vehicles traveling in the adjacent lane are detected, the vehicle control unit 33 may track individual other vehicles by applying a predetermined tracking method such as KLT tracking or ByteTrack to the plurality of exterior sensor signals obtained in time series.

When the target position is set, the vehicle control unit 33 refers to the predicted time at which the target vehicle reaches the front and rear of the target position, the distance from the current position of the vehicle 10 to the target position, and the current speed of the vehicle 10. Then, assuming that the vehicle 10 performs an uniformly accelerated motion, the vehicle control unit 33 sets the target acceleration of the vehicle 10 so that the vehicle 10 reaches a position separated by a predetermined offset distance behind the target vehicle at a predicted time when the target vehicle passes the target position.

The vehicle control unit 33 moves the vehicle 10 to the adjacent lane by controlling the steering, the powertrain, and the brake of the vehicle 10 so that the vehicle 10 travels along the planned traveling trajectory and the vehicle 10 accelerates or decelerates at the target acceleration. When the vehicle 10 moves to the adjacent lane, the vehicle control unit 33 ends the lane change control.

When the speed of the vehicle 10 becomes less than LC lower limit speed prior to or during the execution of the lane change control, the vehicle control unit 33 stops the execution of the lane change control. The LC lower limit speed is a fixed value set in advance. Alternatively, the LC lower limit speed may be a value obtained by subtracting a predetermined offset value from the maximum speed of the road section in which the vehicle 10 is traveling. In this case, the vehicle control unit 33 may specify the maximum speed set for the road section in which the vehicle 10 is traveling and the road section thereof with reference to the map information and the current position of the vehicle 10. Further, the vehicle control unit 33 stops the execution of the lane change control even when the target position cannot be set in a section from the current position of the vehicle 10 to a predetermined distance. The vehicle control unit 33 may notify the driver that the execution of the lane change control is stopped via a notification device (not shown) such as a display device or a speaker.

When the deceleration determination unit 32 notifies that the deceleration condition is satisfied, the vehicle control unit 33 controls the powertrain and the brake so as to execute the deceleration control and decelerate the vehicle 10. When decelerating the vehicle 10 in accordance with the adaptive cruise control, the vehicle control unit 33 decelerates the vehicle 10 at a predetermined deceleration until the distance between the preceding vehicle and the vehicle 10 becomes equal to or greater than a predetermined distance threshold. In addition, when it is predicted that the target vehicle traveling in the adjacent lane will cut in front of the vehicle 10, the vehicle control unit 33 decelerates the vehicle 10 to the target speed. Furthermore, when there is a curve section within a predetermined distance from the current position of the vehicle 10, the vehicle control unit 33 sets the upper limit speed set for the curve section as the target speed after deceleration, and decelerates the vehicle 10 to the target speed until the vehicle 10 enters the curve section. Furthermore, when there is an expressway exit or a tollgate within a predetermined distance from the current position of the vehicle 10, the vehicle control unit 33 sets the upper limit speed that can pass through the exit or tollgate as the target speed after deceleration, and decelerates the vehicle 10 to the target speed until the vehicle 10 passes through the exit or tollgate.

Furthermore, in a case where the adjacent lane is congested, in a case where parallel travel with another vehicle traveling in the adjacent lane is avoided, or in a case where the speed of the vehicle 10 reaches the upper limit speed in PG travel, the vehicle control unit 33 decelerates the vehicle 10 to a predetermined target speed.

In particular, when both the deceleration condition and the lane change condition are satisfied, the vehicle control unit 33 compares the priority of the lane change control with the priority of the deceleration condition. When the priority of the lane change control is higher than the priority of the deceleration control, the vehicle control unit 33 executes the lane change control while executing the deceleration control so that the speed after the deceleration of the vehicle 10 by the deceleration control becomes equal to or higher than LC lower limit speed. Note that the lane change condition may be satisfied after the deceleration condition is satisfied. Therefore, when the priority of the satisfied deceleration condition is lower than the priority of the lane change control stored in the memory 22, the vehicle control unit 33 may set the target speed to be equal to or higher than LC lower limit speed even if the lane change condition is not satisfied. When the lane change condition is not satisfied even after a predetermined period of time has elapsed since the deceleration condition is satisfied, the vehicle control unit 33 may reset the target speed in accordance with the deceleration control being executed. The target speed after resetting may be a speed lower than LC lower limit speed.

Conversely, when the priority of the lane change control is equal to or lower than the priority of the deceleration control, the vehicle control unit 33 executes the deceleration control with priority over the lane change control. That is, the vehicle control unit 33 sets the target speed after deceleration according to the type of deceleration control to be executed. Accordingly, since the deceleration control having a relatively high priority is prioritized over the lane change control, the vehicle control unit 33 can prevent the safety of the vehicle from being impaired. In this case, the vehicle control unit 33 decelerates the vehicle 10 to the target speed required in the deceleration control, and then tries the lane change control. For example, when the deceleration condition corresponding to the control of (a) is satisfied, the vehicle control unit 33 decelerates the vehicle 10 to the target speed even if the target speed after deceleration required in the deceleration control is lower than LC lower limit speed. In a case where the lane change control fails due to the deceleration of the vehicle 10, the vehicle control unit 33 may notify the driver via the notification device that the lane change cannot be executed.

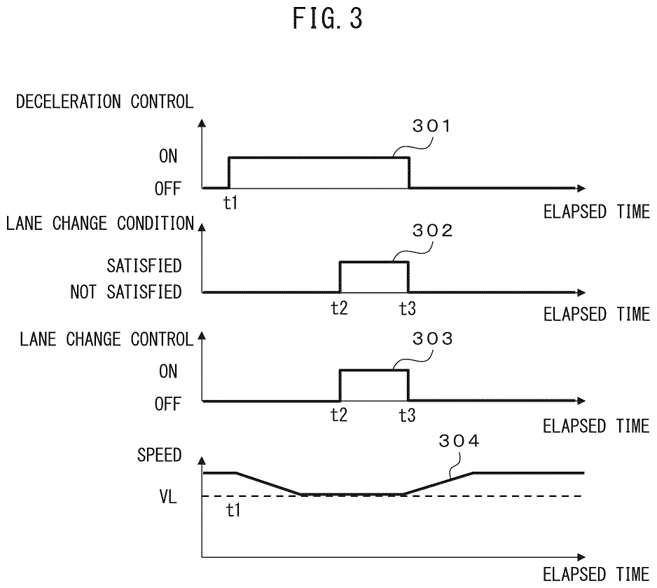

FIG. 3 is a time chart illustrating an example of deceleration control and lane change control. In FIG. 3, the horizontal axis represents elapsed time. From the top, the graphs 301 to 304 represent a temporal change in the presence or absence of execution of the deceleration control, a temporal change in whether or not the lane change condition is satisfied, a temporal change in the presence or absence of execution of the lane change control, and a temporal change in the speed of the vehicle 10. In this example, it is assumed that the priority of the deceleration control is lower than the priority of the lane change control.

In this case, the deceleration condition is satisfied at the time t1, and the deceleration control is started. After the time t1, the velocity of the vehicles 10 decreases. Since the target speed after the deceleration is set to LC lower limit speed VL, the speed of the vehicles 10 is maintained equal to or higher than LC lower limit speed VL even after the deceleration control is started. Consequently, when the lane change condition is satisfied at the time t2, the lane change control is immediately executed, and the lane change control is completed at the time t3. As described above, since the deceleration in the speed of the vehicle 10 due to the deceleration control is suppressed, the execution of the lane change control is not prevented due to the deceleration control.

The updating unit 34 decreases the priority of the lane change control by a predetermined degree when the frequency at which the driver cancels the execution of the lane change control when the lane change condition is satisfied in a latest predetermined period is equal to or more than a predetermined frequency. When the steering is operated so as to direct the vehicle 10 in a direction opposite to the direction toward the adjacent lane of the moving destination, or an operation signal indicating that a switch operation for canceling the execution of the lane change control has been performed is received from an operation device mounted on the vehicle 10, the updating unit 34 determines that the driver has cancelled the execution of the lane change control. Each time the driver cancels the execution of the lane change control, the updating unit 34 increases the count value representing the number of cancellation operations by one. The updating unit 34 decreases the priority of the lane change control by the predetermined degree and resets the count value to 0 each time the count value reaches a predetermined frequency threshold.

Further, the updating unit 34 decreases the priority of the deceleration control by a predetermined degree when the frequency at which the driver cancels the execution of the deceleration control in the latest predetermined period is equal to or more than the predetermined frequency. In this case, for each type of the deceleration control, a count value indicating the number of times the execution of the deceleration control is cancelled is set. When the deceleration control being executed is cancelled, the updating unit 34 increases the count value corresponding to the deceleration control being executed by 1. For example, when the operation of canceling the deceleration is performed during the deceleration of the vehicle 10 by the parallel travelling avoidance control, the updating unit 34 increases the count value of the deceleration control in the parallel travelling avoidance control by 1. When the driver performs an accelerator operation or the operation device notifies that a switch operation for canceling the deceleration control is performed during the execution of the deceleration control, the updating unit 34 determines that the driver has cancelled the execution of the deceleration control. Each time the count value reaches a predetermined frequency threshold, the updating unit 34 decreases the priority of the deceleration control corresponding to the count value by a predetermined degree and resets the count value to 0.

Further, the updating unit 34 may increase the priority of the deceleration control corresponding to the satisfied deceleration condition by a predetermined degree of priority when the frequency at which the driver decelerates the vehicle 10, when the deceleration condition is satisfied and the vehicle 10 is controlled by manual driving, in the latest predetermined period is equal to or more than the predetermined frequency. In this case, the updating unit 34 sets a count value indicating the number of times the driver manually decelerates the vehicle 10 for each type of deceleration control. When the vehicle 10 decelerates by stepping on the brake or by an accelerator operation such that the driver releases the accelerator, the updating unit 34 increases the count value of the deceleration control corresponding to the satisfied deceleration condition by 1. Each time the count value reaches a predetermined frequency threshold, the updating unit 34 increases the priority of the deceleration control corresponding to the count value by a predetermined degree and resets the count value to 0.

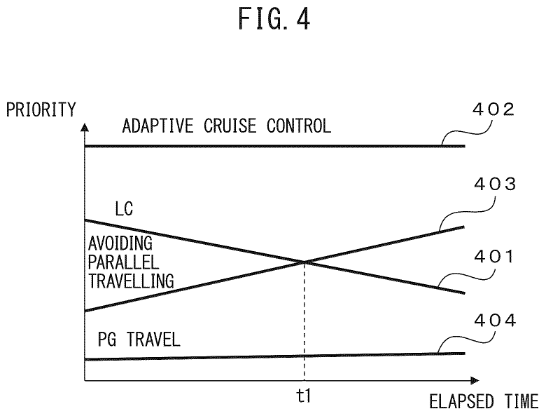

FIG. 4 is a time chart showing an example of the transition of the respective priorities of the deceleration control and the lane change control. In FIG. 4, the horizontal axis represents elapsed time, and the vertical axis represents priority. The graphs 401 to 404 represent time changes in the priority of the lane change control, the priority of the adaptive cruise control, the priority of the parallel travel avoidance control, and the priority of the PG travel control, respectively.

As shown in FIG. 4, since the priority of the adaptive cruise control is always higher than the priority of the lane change control, the deceleration control related to the adaptive cruise control is executed preferentially over the lane change control. On the other hand, since the priority of the PG travel control is constantly lower than the priority of the lane change control, when both the lane change condition and the deceleration condition related to the PG travel control are satisfied, the target speed after deceleration when the deceleration control related to the PG travel control is executed is set to be equal to or higher than the LC lower limit speed so that the lane change control can be executed even during the execution of the deceleration control. Further, until the time t1, since the priority of the parallel travel avoidance control is lower than the priority of the lane change control, the target speed after the deceleration when the deceleration control related to the parallel travel avoidance control is executed is set to be equal to or higher than the LC lower limit speed. After the time t1, the priority of the parallel travel avoidance control is higher than the priority of the lane change control. Therefore, after the time t1, the deceleration control related to the parallel travel avoidance control is executed preferentially over the lane change control.

Since the updating unit 34 adjusts the priority of each control according to the behavior of the driver, the prioritized control of the deceleration control and the lane change control can be adjusted to the preference of the driver. Note that, according to the modification, the processing of the updating unit 34 may be omitted.

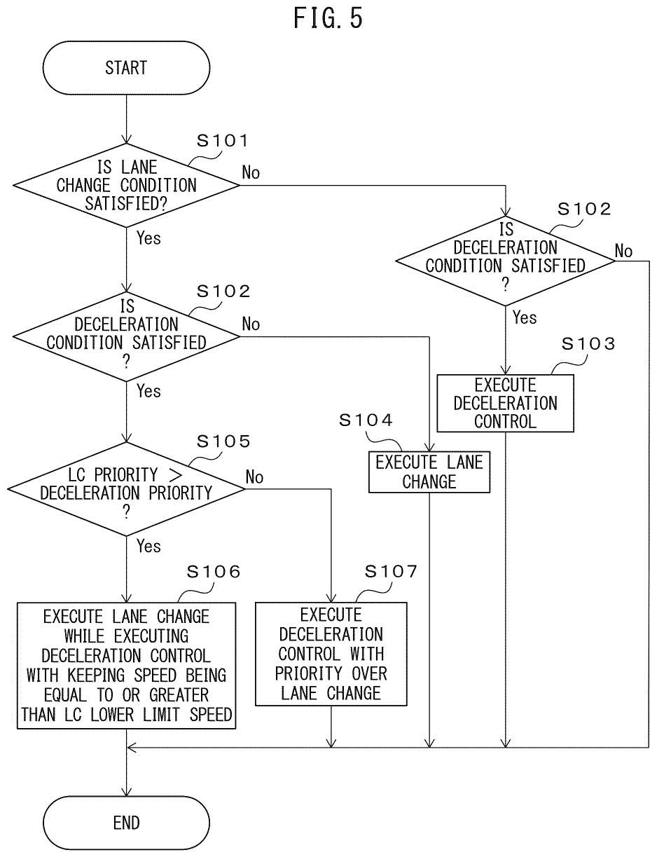

FIG. 5 is an operation flowchart of a vehicle control process according to the present embodiment. The processor 23 executes the vehicle control process according to the following operation flowchart.

The lane change determination unit 31 determines whether or not the lane change condition is satisfied (step S101). Further, the deceleration determination unit 32 determines whether or not the deceleration condition is satisfied (step S102). Note that the processing of the step S101 and the processing of the step S102 may be executed in parallel or may be executed in the reverse order.

When neither the lane change condition nor the deceleration condition is satisfied (No in step S101 and No in step S102), the processor 23 ends the vehicle control process according to the present embodiment, and continues the control of the vehicle 10 that has been executed so far. When the lane change condition is not satisfied and the deceleration condition is satisfied (No in step S101 and Yes in step S102), the vehicle control unit 33 executes the deceleration control (step S103). On the other hand, when the lane change condition is satisfied and the deceleration condition is not satisfied (Yes in step S101 and No in step S102), the vehicle control unit 33 executes the lane change control (step S104). After S103 of steps or S104, the processor 23 ends the vehicle-control process.

When both of the lane change condition and the deceleration condition are satisfied (Yes in step S101 and Yes in step S102), the vehicle control unit 33 determines whether or not the priority of the lane change control is higher than the priority of the deceleration control corresponding to the deceleration condition satisfying the priority of the lane change control (step S105). When the priority of the lane change control is higher than the priority of the deceleration control corresponding to the deceleration condition satisfying the priority of the lane change control (Yes in step S105), the vehicle control unit 33 sets the target speed after the deceleration to a speed equal to or higher than the LC lower limit speed and executes the lane change control while executing the deceleration control (step S106). On the other hand, when the priority of the lane change control is equal to or lower than the priority of the deceleration control corresponding to the deceleration condition satisfying the priority of the lane change control (No in step S105), the vehicle control unit 33 executes the deceleration control with priority over the lane change control (step S107). After S106 of steps or S107, the processor 23 ends the vehicle-control process.

As described above, when the priority of the deceleration control is lower than the priority of the lane change control, the vehicle control device executes the deceleration control so that the speed after the deceleration of the vehicle by the deceleration control becomes equal to or higher than the LC lower limit speed, and executes the lane change control. Therefore, the vehicle control device can decelerate the vehicle so as not to interfere with the execution of the lane change control.

Further, the computer program for realizing the functions of the processor 23 of the ECU 15 according to the above-described embodiment or modification may be provided in a form recorded in a computer-readable portable recording medium such as a semiconductor memory, a magnetic recording medium, or an optical recording medium.

What is claimed is:

1. A vehicle control device comprises:
a processor configured to:
determine whether or not a lane change condition is satisfied based on a position of a vehicle or an operation signal indicating an operation by a driver of the vehicle, the lane change condition being a condition that execution of lane change control for moving the vehicle from a host lane on which the vehicle is traveling to an adjacent lane adjacent to the host lane is required, or the execution of the lane change control is predicted,
determine whether or not a deceleration condition is satisfied based on a behavior signal representing a behavior of the vehicle or an exterior sensor signal representing a situation around the vehicle, the deceleration condition being a condition that execution of a predetermined deceleration control for decelerating the vehicle is required, and
execute the predetermined deceleration control so that the decelerated speed of the vehicle by the predetermined deceleration control is equal to or higher than a lower limit speed at which the lane change control can be executed, and executes the lane change control, when both the lane change condition and the deceleration condition are satisfied, and a priority of the predetermined deceleration control is lower than a priority of the lane change control.

2. The vehicle control device according to claim 1, wherein when both the lane change condition and the deceleration condition are satisfied, and the priority of the lane change control is equal to or lower than the priority of the predetermined deceleration control, the processor executes the predetermined deceleration control with priority over the lane change control.

3. The vehicle control device according to claim 1, wherein the processor is further configured to decrease the priority of the lane change control by a predetermined degree when the frequency at which the driver cancels the execution of the lane change control when the lane change condition is satisfied in a latest predetermined period is equal to or more than a predetermined frequency.

4. The vehicle control device according to claim 3, wherein the processor is further configured to decrease the priority of the predetermined deceleration control by the predetermined degree when the frequency at which the driver cancels the execution of the deceleration control when the deceleration condition is satisfied in the latest predetermined period is equal to or more than the predetermined frequency.

5. The vehicle control device according to claim 3, wherein the processor is further configured to increase the priority of the predetermined deceleration control by the predetermined degree when the frequency at which the driver decelerates the vehicle, when the deceleration condition is satisfied and the vehicle is controlled to be manually driven by the driver, in the latest predetermined period is equal to or more than a predetermined frequency.
